(19) United States
(12) Patent Application Publication
(10) Pub. No.: US 2004/0093294 A1
(43) Pub. Date: May 13, 2004

(54) Method and apparatus for providing measures of performance of the value of an asset

(76) Inventor: George Trevino, San Antonio, TX (US)

Correspondence Address: OCHOA & ASSOCIATES, M. SUSAN SPIERING, ESQ., P. O. BOX 72694, CORPUS CHRIST,, TX, 78472-2694, US

(21) Appl. No.: 10/293,047

(22) Filed: Nov. 13, 2002

(51) Int. Cl. G06F 17/60

(52) U.S. Cl. 705/36

(57) ABSTRACT

A method for providing one or more real-time measures of the performance of an asset. The price of an asset is represented as the sum of a time-dependent average and a random part, defined as a deviation from the average. Straightforward definitions of drift, volatility and risk are obtained. In accordance with embodiments of the invention, real-world stock price information generates time-dependent drift, volatility and risk, assigning an added dimension to the underlying value of an asset.

### TECHNICAL FIELD

The present invention relates to the valuation of an asset of fluctuating value, and, more particularly, to the analysis of time series in an improved model for describing market return.

### BACKGROUND OF THE INVENTION

The state-of the-art model for describing the time-varying price of a financial asset begins by expressing the price difference, ΔP(t)=P(t+Δt)−P(t), where P(t) is the function describing asset price as a function of time, t, in terms of an Ito process, as described by Itô, “On stochastic differential equations,” Memoirs of the American Mathematical Society, Vol. 4, 1951, pp. 1-51, which is incorporated herein by reference. In accordance with current practice, price differences are expressed as:

ΔP(t)=F(P)Δt+G(P)ΔW(t) [1]

where F(P)=γP(t), G(P)=σP(t) and W(t) is a Wiener process of zero average value. Wiener processes, discussed further herein, are discussed in detail in Priestley, Spectral Analysis and Time Series, (Academic Press, 1981), also incorporated herein by reference. The parameters λ and σ are referred to herein, respectively, as the “drift” and “volatility” associated with the process. In further accordance with current practice, drift and volatility are typically assumed to be constant and independent of one another, even though, in reality, they are neither, as has been pointed out by Rebonato, Volatility and Correlation in the Pricing of Equity, FX and Interest-Rate Options, Wiley, 1999). Δt is called the sampling interval and in financial analyses may be as small as roughly 15-s or as large as the user desires.

Formulating price differences as in Eqn. [1] leads to an expression for the price of an asset as the product of two factors, an exponential ‘growth’ term and a stochastic factor having an average value of unity (i.e., “1”), as shown in Eqn. [4], below.

Defining characteristics of a Weiner process W(t) include that it: (i) is Gaussian; (ii) has zero average; (iii) has variance that grows linearly with time; and (iv) has uncorrelated increments. In expanded form, Eqn. [1] may be expressed as

ΔP(t)=λP(t)+σP(t)ΔW(t)=P(t){λ+σn(t)}Δt [2]

indicating that price differences are specified as the product of two random functions, viz. P(t) and λ+σn(t), where n(t) is uncorrelated zero-average Gaussian noise. The term “uncorrelated” means that, for any t, the value of n(t) is independent of both previous and subsequent values, viz. n(t−Δt) and n(t+Δt). Gaussian noise is characterized by identity of the mode, median and mean (average) of the random behavior. Zero-average Gaussian noise is therefore noise whose mode and median are also zero.

To the rank-and-file investor, such a formulation, although convenient for defining return, ΔP/P (see Eqn. [5] below), is impractical because real-world price differences rarely behave in the indicated manner. Specifically, drift and volatility are time dependent, as opposed to constant, and real-world price differences are more general than that described by Eqn. [2]. FIG. 1 shows histograms of prices of the S&P 500 for the months of January (curve 10) and February 1999 (curve 12). FIG. 2 shows the histograms of S&P successive price differences for the same months (curves 14 and 16, respectively), with a closed form approximation to both differences superposed (curve 18); note the consistent almost time-invariant non-Gaussian structure. The depicted closed form approximation is the Cauchy-type curve of the form:

$$H ( Δ P ) = \frac{13500}{1 + {( \frac{Δ P - 3}{8} )}^{2}} . \qquad [ 3 ]$$

The lack of well-defined structure in the histograms of prices reflects the fact a simple relationship such as [2] will not transform the histograms depicted in FIG. 1 into the histograms of FIG. 2. That is, the histograms of prices and the histograms of price differences are not related to one another as epecified by Eqn. [2]. More specifically, the histogram of ΔP/P is not defined by the histogram of {λ−0.5σn(t)}Δt. Hence, there is no justification, other than the noted convenient and seemingly appropriate properties of Weiner processes, for assuming the time histories specified by Eqn. [2].

The prior art then invokes Itô's Lemma (see Itô, op. cit.) to produce, from [2],

P(t)=P₀exp{(λ−0.5σ²)t}exp{σW(t)} [4]

as the expression describing the time history of price fluctuations (Nielsen, Pricing and Hedging of Derivative Securities, (Oxford, 1999)), where the quantity 0.5σ² (>0) is referred to in the prior art as the risk and the quantity (λ−0.5σ²)<λ is referred to as the risk-adjusted drift. This is the accepted expression for the price of an asset, and when Eqn. [4] is plotted as a function of time, P(t) looks like a random walk scaled along the ordinate by the time-dependent effects of risk-adjusted drift.

An unfortunate feature of Eqn. [4] is that it does not come with a prescribed way of determining either λ or σ from the history of P(t). Even the time history of W(t) is left to choice since it's defined as ∫n(γ)dγ, where n(t) is uncorrelated zero-average Gaussian noise. Another unfortunate feature is that, since σ² is always positive, it follows that risk-adjusted drift is always less than drift, which is inconsistent with the notion of riskless portfolios.

Some analysts believe that volatility is associated with a decline in asset price (Bernstein, Against the Gods, Wiley, 1996, p. 260; Sorensen, “The derivative portfolio matrix—combining market direction with market volatility,” Institute for Quantitative Research in Finance, Spring 1995 Seminar) while others (e.g., Schwert, “Why does stock market volatility change over time?,” Journal of Finance, 1989, pp. 1115-1153; Ball and. Torous, “The stochastic volatility of short term interest rates: some international evidence,” Journal of Finance, 1999, pp. 2339-2359) report inconclusive results. Even the causes of volatility are the topic of debate (Bernstein, p. 260). A definition of the origin of volatility and of its time evolution is thus desirable and is advantageously provided in accordance with the present invention.

### DESCRIPTION OF RELATED ART

The analysis of stock market fluctuations focuses on a quantity called return, defined as the ratio of the instantaneous change in a particular stock price to the instantaneous price itself. In equation form, the prevailing model of return may be cast as

$$\frac{Δ P ( t )}{P ( t )} = \frac{P ( t + Δ t ) - P ( t )}{P ( t )} = ( λ - 0.5 {σ}^{2} ) Δ t + σ Δ W \qquad [ 5 ]$$

where t is continuous time, and, as discussed above, X and a are constants independent of each other.

Return is dimensionless, easy to compute, and is typically specified as a percentage. An investment of $X on one day sold the next day for $Y returns (Y−X)/X. A presumed advantage of an expression such as Eqn. [5] is that it allows one to estimate future return on the basis of currently known values of drift and volatility. Drift and volatility, however, are non-observable quantities and therefore such estimates must assume that the collective market behavior is ideal and will remain so between the present and a specified future time.

In ‘phynance’ (phy-sics and fi-nance) literature (e.g., Paul and Baschnagel, Stochastic Processes: From Physics to Finance, Springer, 1999), Eqn. [5] is derived consistently with stochastic calculus (Mikosch, Elementary Stochastic Calculus, World Scientific, 1998), Itô's Lemma, and Wiener processes. Note, however, that Eqn. [5], like Eqn. [4], does not describe a unique way, or any way at all, to specify drift or volatility from a given P(t), but only that return can, under the above conditions, be modeled as indicated.

The uncorrelated-increments property of Wiener processes insures that return is not predictable to any degree (Lo and MacKinlay, A Non-Random Walk Down Wall Street, Princeton, N.J., 1999). Weiner processes are invoked because it's well known that the sign of a price increment, defined as

$$\frac{Δ P}{\vert Δ P \vert} ,$$

where vertical bars ∥ denote absolute value, is uncorrelated with the sign of the preceding (or succeeding) increment. That is, as time advances, the price of an asset can go either up or down, or stay the same, regardless of where it is now or where it was previously. Mathematically, this requires that

$$\frac{Δ P}{\vert Δ P \vert}$$

can be either +1 or −1 with equal probability (Paul and Baschnagel, p. 168) and therefore that ΔP(t)=|ΔP(t)|Z(t), where Z(t) is the telegraph signal (Papoulis, Probability, Random Variables, and Stochastic Processes; McGraw-Hill, 1965). The case where ΔP=0 is considered to represent a positive sign, by definition.

The analytical value of Eqn. [5] is assessed by recognizing that, if there are no oscillations in price, return is defined exclusively by drift. If drift is constant, the price of the asset grows exponentially over time, a condition favorable to investors. When randomness is present, though, it creates risk, defined in Eqn. [5] as one-half the square of volatility, and long-term exponential growth of an asset is thus defined by (λ−0.5σ²) rather than exclusively by λ The fact that risk is defined in terms of volatility is what induces many investment professionals to equate the two. In other words, investment analysts believe that if the volatility of a particular price fluctuation is known then so is the risk. A more realistic analysis is provided in accordance with the present invention as described in detail below.

The Gaussian property of Wiener processes is also uncommon in real-world stock price fluctuations (Bouchaud and Potters; Theory of Financial Risks, Cambridge, 2000). So is the uncorrelated increments property to some degree, particularly over small values of Δt. Moreover, a variance that grows linearly with time is rarely found in real markets; and real-world market drift and volatility are strictly not independent of one another (Rebonato, op. cit.). Lastly, the mathematical peculiarities of stochastic calculus are not common knowledge among rank-and-file investors and therefore such individuals have no way of realistically assessing market oscillations at hand, even in the ideal case, for purposes of making prudent investment decisions.

### SUMMARY OF THE INVENTION

In view of the foregoing shortcomings, the present invention provides an improved model for analyzing stock market price fluctuations and from there determines the instantaneous drift, volatility and risk to associate with a particular asset. In accordance with preferred embodiments of the present invention, an improved model is provided to enable a method for describing market return. Specifically, the invention models time-dependent stock price fluctuations (sometimes called asset price fluctuations)—denoted P(t)—in a manner compatible with the prevailing model but produces return parameters, viz. drift, volatility and risk, readily recognizable from ordinary statistics of asset price behavior, viz. average and standard deviation. In the prevailing model, such is not the case.

In accordance with embodiments of the present invention, an expression is provided for risk that is not equal to one-half the square of volatility, except in special cases. Rather, risk is equal to the derivative of the square of the ratio of two functions, the first: a running average, and the second: a stochastic term of differences.

In accordance with preferred embodiments, a method is formulated for providingg at least one real-time measure of performance of the value of an asset characterized by a price. The method has steps of:

a. calculating a running average of the price of the asset defined over a specified time duration and at specified instants;

b. calculating at each specified instant a time-dependent deviation from the running average;

c. expressing the price of the asset as a sum of the time-dependent running average plus a set of time-dependent deviations from the running average;

d. associating with the asset a measure of performance of the value of the asset based at least on time derivatives of a function of the average function and the standard deviation of the time-dependent differences.

In accordance with other embodiments of the invention, there may also be a step of expressing the set of time-dependent deviations from the running average as a product of a standard deviation and a set of deviations of unit variance. The measure may be a drift equal to the ratio of the time derivative of the average to the average. Alternatively, the measure may be a volatility equal to a ratio of the standard deviation to the product of the average function and a square root of an elapsed duration. In yet further embodiments, the measure may be a risk proportional to a square of the ratio of the standard deviation to the average, or a return equal to the product of risk-adjusted drift and a specified time interval plus a difference in the ratio of the rapidly changing part to the average, corresponding to the specified time interval.

In accordance with further embodiments of the invention, a method is provided for presenting an investor with a choice of investments. The method has steps of presenting a list of assets and characterizing each asset in the list by a drift value, a volatility value, and a risk value, wherein the risk, volatility, and risk values are established as described above.

In accordance with yet further embodiments of the invention, a computer program product is provided for providing at least one real-time measure of performance of the value of an asset characterized by a price. The computer program product has an averager for calculating an average function equal to a time-ordered set of running averages of the price of the asset over a specified number of intervals, each of a specified duration, and a differencer for calculating a time-ordered set of time-dependent differences of the price of the asset with respect to the running averages of the price of the asset at each of the specified intervals. The computer program product has a computer program code module for expressing a price fluctuation function of the asset as a sum of the average function plus the time-ordered set of time-dependent differences, and another computer program code module for associating with the asset a measure of performance of the value of the asset based at least on time derivatives of a function of the average function and the standard deviation of the time-dependent differences.

It is shown herein, that the presence, in Eqn. [5] of the prior art, of the term −0.5σ² within the expression (λ−0.5σ²) is due exclusively to the unique nature of Weiner processes, namely, random behavior which, as suggested above, has minimal semblance to real-world market fluctuations. If the random part of price fluctuations is instead described by something other than a Wiener process, another term manifests in place of −0.5σ² and reduces to −0.5σ² only when asset price behavior is described by the ideal formulation. It's further shown that risk is the time-derivative of the square of the ratio of standard deviation to the average of price fluctuations and is related to volatility only to the extent that volatility is also defined in terms of, but not exclusively by, standard deviation and average. In other words, risk assessment requires more information than just knowledge of instantaneous volatility (cf. Voit, The Statistical Mechanics of Financial Markets, Berlin, 2001).

For example, if the ratio of standard deviation to the average is constant, there is still volatility but no risk, a result contrary to prevailing financial wisdom. The invention thus produces a model of return that determines drift, volatility and risk under a variety of conditions. Such a model is requisite for investors to have a “rule-of-thumb” yet accurate measure of where the market is at present—how “volatile” and “risky”—and where it's going—up (bull), down (bear), sideways (neutral). It's no secret among market analysts that there is a need to have displayed, next to current asset price, a reliable current assessment of these parameters. The intrinsic value of an asset will then be determined by the numbers representing each of current: price, drift, volatility, risk and return. Particular applications include volatility arbitrage, long-short volatility portfolios, volatility swaps, and risk arbitrage. The defined measures of volatility and risk specified by the present invention, may then advantageously be employed in allocating funds for investment.

More specifically, the instantaneous price of an asset is modeled as the superposition of a slowly varying average and a rapidly changing random part, as opposed to modeling price differences as the product of two random time series. From the posed model, volatility is defined in terms of current time and the ratio of standard deviation to average of price fluctuations, while drift is defined as time-derivative-of-the-average divided by the average. Risk is defined as the time-derivative of the square of the ratio of standard deviation to the average. Because volatility, drift and risk are so defined, there is a unique relationship between them. Specifically, changes in drift automatically imply changes in volatility and risk. Changes in volatility, however, can occur with no change in drift. This non-commutative relationship is consistent with known market behavior; e.g., it's possible for volatility to vary while the market remains in a neutral state. This relationship is not obvious from the accepted model of return, where drift and volatility are assumed independent of one another, and volatility and risk are taken to be synonymous.

Moreover, volatility as intended here is a parameter defined from two fundamental properties of a random time series which itself need not be Gaussian or have either uncorrelated increments or a variance that grows linearly with time. That is, volatility here is defined entirely from actual, as opposed to idealized, stock price fluctuations. Because of this, volatility as defined here is always representative of real market behavior. Lastly, the model is such that if real-world price fluctuations do behave in an idealized manner, the model produces the same results as would the prevailing model. In other words, the model posed here reduces to the idealized model whenever market behavior is ideal. All features and advantages of the present invention will become apparent in the following detailed written description.

### BRIEF DESCRIPTION OF THE DRAWINGS

The foregoing features of the invention will be more readily understood by reference to the following detailed description taken with the accompanying drawings:

FIG. 1 shows histograms of prices of the S&P 500 for the months of January and February 1999;

FIG. 2 shows the histograms of S&P successive price differences for the same months, with a closed form approximation to both differences superposed; note the consistent almost time-invariant non-Gaussian structure; and

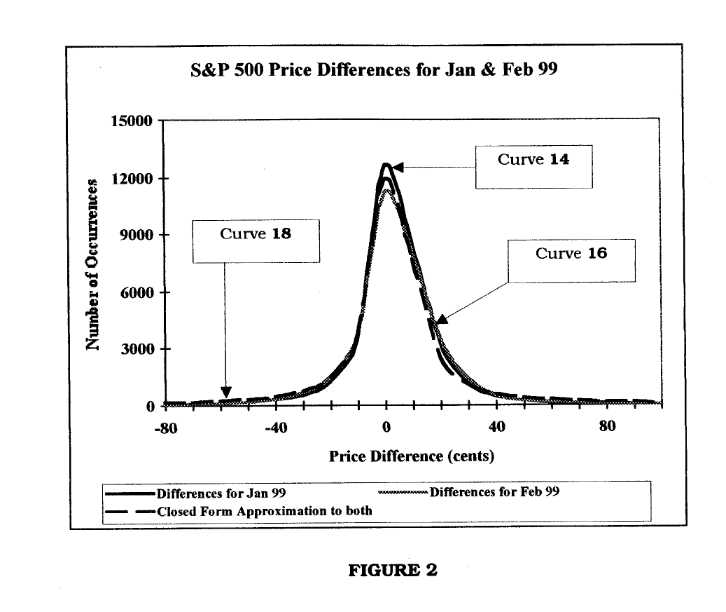

FIG. 3 is a flow chart depicting the derivation of measures of asset price performance in accordance with preferred embodiments of the present invention.

### DETAILED DESCRIPTION OF PREFERRED EMBODIMENTS

The present invention pertains to the analysis of financial time series data. The focus of the invention is a first principles model of market return compatible with real-world market behavior and the estimation of the three parameters used to quantify return, viz. drift, volatility and risk.

In accordance with preferred embodiments of the present invention, asset price is modeled as the sum of two random functions. One is slowly varying peculiar to time-dependent average, the other a totally random component peculiar to the random oscillations in price. The invention identifies drift, volatility and risk in terms of standard deviation and average of P(t), standard deviation and average being fundamental and unique to random movements in general, and readily determined from a history of price fluctuations. The invention also models the random character of the price fluctuations being analyzed from a time history of P(t) as opposed to a Wiener process. In particular, it models drift as the ratio of time-derivative-of the-average to the average itself, volatility as the ratio of standard deviation to average-multiplied-by-the-square-root-of-instantaneous (or current)-time, and risk as one-half the time-derivative of the square of standard-deviation/average. Because of the way it's defined, risk can sometimes be negative in which case risk-adjusted drift is greater than drift, opposed to exclusively less than drift as is the case in the traditional formulation. Note that drift and risk are defined entirely from statistical properties of price fluctuations while volatility combines average and standard deviation with current time. Accordingly, all three can be readily quantified for any type of asset price behavior, revealing how drift, volatility and risk emerge and evolve with time in a given market condition. In financial circles, the term heteroskedasticity is sometimes used to denote time-dependent volatility.

In accordance with the present invention, the price P(t) of a particular stock, stock index, or other asset of value, is represented not as indicated in Eqn. [4] but rather as the sum

P(t)=μ(t)+χ(t), [6]

where μ(t) is the slowly varying time-dependent average and χ(t) the (zero average) random part. Such a representation for a random time series is standard, universally accepted, and can be found in any text on the analysis of random data (see, for example, J. Bendat and A. Piersol; Random Data: Analysis and Measurement Procedures, Wiley, 1971). Ideally, the time dependence of μ(t) for a particular asset is that of an increasing exponential but, on a day-to-day (or week-to-week) basis, this is not always the case, particularly in those instances of market “crashes.”

The expression for price differences peculiar to Eqn. [6] is

$$Δ P ( t ) = Δ μ + Δχ = \frac{ⅆ μ}{ⅆ t} Δ t + Δχ , \qquad [ 7 ]$$

which is the sum of a low-frequency time-dependent function,

$$viz . \frac{ⅆ μ}{ⅆ t} Δ t ,$$

and one random function, viz. Δχ. Because it is the sum of two random functions, this formulation for price differences is fundamentally different from that described in Eqn. [2]. Moreover, the random function χ(t) in Eqn. [6] is defined from recorded behavior of P(t) and does not necessarily reflect Wiener process features.

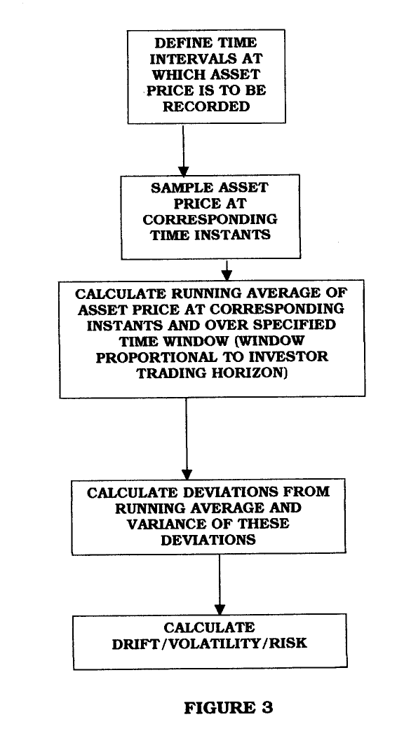

Specifically, from a recorded history of a particular asset price behavior, P(t) is specified as a set of time-ordered time-value pairs which includes a current value. Referring now to FIG. 3, a flowchart is shown depicting the process of applying the model described herein, in accordance with preferred embodiments of the present invention. From the set of time-value pairs, the current average is defined as

$$μ ( {t}_{c} , N ) = \frac{1}{N} {\sum }_{j = 0}^{N} P ( {t}_{c} - j Δ t ) \qquad [ 8 ]$$

where P(t_{c}−jΔt), j=0, 1, 2, . . . ,M>N, is a set of time-ordered time-value pairs already recorded and N is the user-specified number of time-value pairs used the define the current average.

For example, suppose M=61 time-value pairs up to the current pair of a particular asset price have been recorded at a sampling rate of one-per-minute (one hour total of time-value pair samples) and that the present time t_{c} is 11:46 a.m. These 61 time-value pairs are written as P(10:46), P(10:47), P(10:48), etc., on to P(11:45) and P(11:46). The current 20-min average for this asset is

$$μ ( 11 : 46 , 20 ) = 0.05 \{ \begin{matrix}P ( 11 : 27 ) + P ( 11 : 28 ) + P ( 11 : 29 ) + \\ … + P ( 11 : 45 ) + P ( 11 : 46 )\end{matrix} \} . \qquad [ 9 ]$$

The 20-min average for 11:45 is

$$μ ( 11 : 45 , 20 ) = 0.05 \{ \begin{matrix}P ( 11 : 26 ) + P ( 11 : 27 ) + P ( 11 : 28 ) + \\ … + P ( 11 : 44 ) + P ( 11 : 45 )\end{matrix} \} , \qquad [ 10 ]$$

and the 20-min average for 11:06 is

$$μ ( 11 : 06 , 20 ) = 0.05 \{ \begin{matrix}P ( 10 : 47 ) + P ( 10 : 48 ) + P ( 10 : 49 ) + \\ … + P ( 11 : 05 ) + P ( 11 : 06 )\end{matrix} \} . \qquad [ 11 ]$$

These, and all intervening 20-min averages, viz. those for 11:07, 11:08, 11:09, etc., on to 11:43 and 11:44 a.m., 41 total 20-min averages, are the time-value averages designated in Eqn. [6] as μ(t).

From these are determined the related χ(t), viz. those for 11:06, 11:07, etc., on to 11:46, according to

χ(11:46)=P(11:46)−μ(11:46,20), [12]

χ(11:45)=P(11:45)−μ(11:45,20), [13]

χ(11:44)=P(11:44)−μ(11:44,20), [14]

and so on until

χ(11:06)=P(11:06)−μ(11:06,20). [15]

These are the time-dependent deviations from 20-minute averages designated in Eqn. [6] as χ(t). There is no guarantee that these deviations will adhere to the features of Weiner-process behavior for all time. Note that even though one hour of price data has been recorded, because averages are taken over a time window of 20 minutes, only 41 usable averages and deviations from the average are available.

From these 41 deviations are determined the 40 time-value difference pairs

Δχ(11:45,20)=χ(11:45,20)−χ(11:44,20), [16]

Δχ(11:44,20)=χ(11:44,20)−χ(11:43,20), [17]

and so on until

Δχ(11:07,20)=χ(11:07,20)−χ(11:06,20). [18]

These are the time-dependent differences designated in [7] as Δχ(t). The time-dependent differences between the 20-min averages are defined as

Δμ(11:46,20)=μ(11:46,20)−μ(11:45,20), [19]

Δμ(11:45,20)=μ(11:45,20)−μ(11:44,20), [20]

Δμ(11:44,20)=μ(11:44,20)−μ(11:43,20), [21]

and so on until

Δμ(11:07,20)=μ(11:07,20)−μ(11:06,20). [22]

The expression for return compatible with Eqn. [6] is derived as follows. The average of P(t) is always positive, as is P(t) itself. Since χ(t), though, is defined as a deviation from the average, it manifests both positive and negative values. Since the price of an asset must always be positive, the maximum absolute value of deviations from the average must always be less than the average for all time. Mathematically this is written as MAX{|χ(t)|}<μ(t), where vertical bars 11 denote absolute value. That is, the absolute value of the random part of an asset can never be large enough that the value of the asset itself dips below zero for any particular instant of time. For purposes here this relation is numerically invoked to the extent that, when compared to unity, quantities of the order (χ/μ)₃ are negligible while those of the order (λ/μ)² and λ/μ are not. For example, if λ/μ is at most 0.3, then (λ/μ)² is at most 0.09 and (λ/μ)³ is at most 0.027. The first two are not negligible when compared to unity but the third is. This constraint is not necessary in the prevailing model of price fluctuations since there the random part is defined as an exponential oscillating about unity. This constraint approximates stock price fluctuations well even in cases of high volatility.

Some immediate differences, then, between Eqn. [6], in accordance with the present invention, and Eqn. [4] of the prior art, are: (i) the average of the random part, in the prior art, is unity while in Eqn. [6] the average of the random part is roughly zero; and (ii) the invention can be adapted to represent real market behavior even in extreme cases. The prevailing model is a consequence of the fact that the original model, formulated by Bachelier (L. Bachelier, Theorie de la speculation, Doctoral Dissertation, Faculte de Sciences de Paris, 1900; translated into English in Cootner, The Random Character of the Stock Market, MIT Press, 1964), permitted the unrealistic possibility of negative asset prices.

To reconcile Eqn. [6] with Eqn. [4], let χ(t)=σμ(t)W(t). This randomness is described by all the properties of Wiener processes except that it has variance equal to σ²μ²t. With Eqn. [6] as a starting point, return expresses as the infinite series

$$\frac{Δ P ( t )}{P ( t )} = \frac{Δ μ ( t )}{μ} + \frac{σ Δ W}{1 + σ W} \approx \frac{Δ μ ( t )}{μ} + σ Δ W ( 1 - σ W + {σ}^{2} {W}^{2} … ) . \qquad [ 23 ]$$

For μ(t)=P₀exp(λt), Eqn. [23] reduces to

$$\frac{Δ P ( t )}{P ( t )} \approx ( λ - 0.5 {σ}^{2} \frac{ⅆ {W}^{2}}{ⅆ t} ) Δ t + σ Δ W = ( λ - 0.5 {σ}^{2} ) Δ t + σ Δ W , \qquad [ 24 ]$$

since by definition

$$\frac{ⅆ {W}^{2}}{ⅆ t} = 1.$$

Note that Eqn. [24] is identical to [5] but was derived without use of stochastic calculus or Itô's Lemma. This result is to be expected since return is a physically realizable quantity and should accordingly be independent of how price fluctuations are modeled. The advantage of the formulation at hand, though, is described below.

In the prevailing model of return, the term that's added to drift reduces to −0.5σ² by virtue of ‘invoking’ Itô's Lemma (Itô, op. cit., pp. 1-51). Here, though, the term added to drift is a consequence of representing the random part of the asset price as χ═σμW, where σ is constant, μ is the average of asset price, and W(t) a Wiener process, and further imposing the condition that only those terms of the order (χ/μ)₃ and higher are negligible when compared to unity. In other words, in the formulation posed here, knowledge of stochastic calculus is not requisite for understanding how −0.5σ² manifests in return.

For the case where χ(t) is not representable as σμW, let (μ+χ)⁻¹ become

$${μ}^{- 1} [ 1 - \frac{χ}{μ} + {( \frac{χ}{μ} )}^{2} + … ] ;$$

return accordingly writes as the infinite series

$$\frac{Δ P ( t )}{P ( t )} \approx \frac{Δ μ ( t )}{μ} [ 1 - \frac{χ}{μ} + {( \frac{χ}{μ} )}^{2} + … ] + \frac{Δ χ ( t )}{μ} [ 1 - \frac{χ}{μ} + {( \frac{χ}{μ} )}^{2} + … ] , \qquad [ 25 ]$$

where, as specified above, terms on the order (χ/μ)³ have been neglected. The term

$$- ( \frac{Δ χ}{μ} ) ( \frac{χ}{μ} )$$

reduces to

$$- \frac{1}{2 {μ}^{2}} \frac{ⅆ {χ}^{2}}{ⅆ t} Δ t ;$$

this combines with

$$\frac{Δ μ ( t )}{μ} {( \frac{χ}{μ} )}^{2}$$

to form

$$- \frac{1}{2} \frac{ⅆ}{ⅆ t} {( \frac{χ}{μ} )}^{2} Δ t .$$

The two terms

$$- \frac{Δ μ ( t )}{μ} ( \frac{χ}{μ} ) and \frac{Δ χ ( t )}{μ}$$

likewise combine to form

$$Δ ( \frac{χ}{μ} ) .$$

The corresponding expression for return is then

$$\frac{Δ P ( t )}{P ( t )} \approx ( \frac{1}{μ} ( \frac{ⅆ μ}{ⅆ t} ) - \frac{1}{2} \frac{ⅆ}{ⅆ t} {( \frac{χ}{μ} )}^{2} ) Δ t + Δ ( \frac{χ}{μ} ) . \qquad [ 26 ]$$

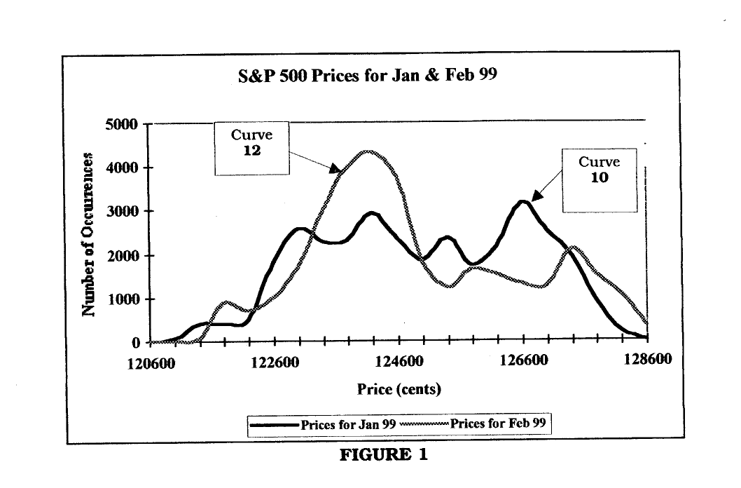

Thus, an added feature of the invention is that when the random part of asset price cannot be represented as σμW, the term that's added to drift (i.e. risk) is specified as the time-derivative of −0.5(χ/μ)², a small but non-negligible term. An equivalent way of expressing χ is as P−μ so χ/μ=P/(μ−1). In view of the histogram depicted in FIG. 1, it is unlikely that, in Eqn. [26], Δ(χ/μ) will be Guassian for real-world market prices.

The significance of Eqn. [26] is that it applies to any type of random behavior. Specifically, the ratio χ/μ is the ratio of the time-dependent deviations from the average, as described in Eqns. [12]-[14], and the time-dependent average, as prescribed in Eqns. [9]-[11]. In the idealized model, risk is governed exclusively by properties of a random process, viz. a Wiener process, which has minimal applicability to real-world market behavior. In Eqn. [26] risk is governed by the time-derivative of the market-defined statistics of P(t).

Specifically, risk-adjusted drift is defined as the difference between drift (i.e., the ratio of the time-derivative of the average to the average) and one-half the time derivative of the square of the ratio of the rapidly changing part to the average. The second term in the expression for return is the difference in the ratio of the rapidly changing part to the average corresponding to the interval Δt.

For ideal behavior, this result simulates the prior art formulation, as follows by expressing χ(t) as α(t)Y(t), where α(t)>0 is the time-dependent standard deviation of χ(t) and Y(t) is a process which is Gaussian, has uncorrelated increments, but has unit variance. Such a decomposition is standard for all random time series. An estimate of Y(t) for the example discussed in Eqns. [12] thru [15] is found by squaring the 21 deviations from the average determined in accordance with Eqns. [12] through [15] for the times 11:06, 11:07, 11:08, . . . ,11:26, adding those 21 positive values and dividing by 20. The quotient is the variance of the price at 11:26, denoted α²(11:26). Only 21 deviations are used because by taking 20-minute averages of the price, the investor has indicated she is interested in quantifying price behavior over a 20-minute window. This window is sometimes called the investor trading horizon. A similar procedure is followed for the times 11:07, 11:08, 11:09, . . . ,11:27, and this quotient is the variance at 11:27, denoted α²(11:27). Variances for 11:28, 11:29, 11:30, . . . ,11:46 are similarly obtained yielding a total of 21 variances, one for each of the times 11:26, 11:27, 11;28, . . . , and 11:46, the current time. The function Y(t) is then defined as χ(t)/α(t), defined, however, only for the 21 time instants 11:26, 11:27, 11:28, . . . ,11:46.

For this description of the random part of price oscillations, Eqn. [26] becomes

$$\frac{Δ P ( t )}{P ( t )} = ( ( \frac{1}{μ} ) \frac{ⅆ μ}{ⅆ t} - \frac{1}{2} \frac{ⅆ}{ⅆ t} {( \frac{α}{μ} )}^{2} ) Δ t + Δ \{ ( \frac{α}{μ} ) Y \} , \qquad [ 27 ]$$

where χ²=α²Y²=α².

The volatility is accordingly defined by rewriting Eqn. [27] as

$$\frac{Δ P ( t )}{P ( t )} = ( ( \frac{1}{μ} ) \frac{ⅆ μ}{ⅆ t} - \frac{1}{2} \frac{ⅆ}{ⅆ t} {( \frac{α}{μ} )}^{2} ) Δ t + Δ \{ ( \frac{α}{μ \sqrt{t - {t}_{o}}} ) \sqrt{t - {t}_{0}} Y \} , \qquad [ 28 ]$$

where \sqrt{t−t₀}Y plays the role of a Wiener process. For the example discussed in Eqns. [12] through [15],

$$\frac{α}{μ \sqrt{t - {t}_{0}}}$$

is the set of the 21 values

$$\frac{α ( 11 : 26 )}{μ ( 11 : 26 ) \sqrt{20}} ,$$

$$\frac{α ( 11 : 27 )}{μ ( 11 : 27 ) \sqrt{20}} , \frac{α ( 11 : 28 )}{μ ( 11 : 28 ) \sqrt{20}} , … , \frac{α ( 11 : 46 )}{μ ( 11 : 46 ) \sqrt{20}} .$$

Note that t−t₀=20 minutes is constant throughout the determination because at eacj instant of time the investor wants to incorporate the effects of only the most recent 20 minutes of price information.

Setting

$$\frac{α}{μ \sqrt{t - {t}_{0}}}$$

equal to σ (volatility) converts [28] into

$$\frac{Δ P ( t )}{P ( t )} = ( ( \frac{1}{μ} ) \frac{ⅆ μ}{ⅆ t} - \frac{1}{2} \frac{ⅆ}{ⅆ t} {( {σ}^{2} t )}^{2} ) Δ t + Δ \{ σ \sqrt{t} Y \} . \qquad [ 29 ]$$

If, now, σ is set equal to a constant, Eqn. [29] reduces to

$$\frac{Δ P ( t )}{P ( t )} = ( ( \frac{1}{μ} ) \frac{ⅆ μ}{ⅆ t} - \frac{1}{2} {σ}^{2} ) Δ t + σΔ ( \sqrt{t - {t}_{0}} Y ) . \qquad [ 30 ]$$

which for exponential growth in μ is identical to [5]. If volatility is not constant, Eqn. [29] then incorporates the effect of volatility derivative, a relatively new parameter used in the determination of market response function (G. Zumbach and P. Lynch, “Heterogeneous volatility cascade in financial markets,” Physica A, Vol. 298, 2001, pp. 521-529).

One way to use Eqn. [26] depends on investor interest and the time scale of that interest. For example, if the investor is interested only in return over, say, a 30-day period, then return 30 days from now can be estimated as the average of daily 30-day returns for, say, the previous 30 days. The “previous 30 days” procedure, though, may vary from one investor to another, some not wanting to go back that far. For an investor who trades on volatility, the volatility measure developed herein, viz. standard deviation of price divided by average price divided again by square-root of investor trading horizon, can be used to estimate instantaneous volatility of any stock whose price history is known. Volatility 30 days from now can estimated as the average of volatility over the previous 30 days. For someone who is interested in risk assessment, the risk measure derived herein can be used to estimate instantaneous risk, etc.

A convenient way to interpret of α/μ in Eqn. [27] is as follows. P(t) is a nonstationary time series whose average (mean value) is μ(t)>0 and standard deviation is α(t). Therefore, P/μ is a time series whose average is unity (i.e., “1”) and standard deviation is α/μ. Thus if P/μ is stationary, the risk term in Eqn. [28] is zero, since stationary time series have time-invariant statistics. Examination of Eqs. [29] and [30], however, establishes that, since there's nothing in the definition of volatility requiring the market-defined values of μ or α to be strictly time-dependent (nonstationary), volatility is thus an exclusive property of randomness in price fluctuations only, and not necessarily a property of nonstationarity as suggested by some experts (See, for example, Liu et al., “Statistical properties of the volatility of price fluctuations,” Physical Review E, Vol. 60, (1999), pp. 1390-1400). In the prior art, volatility is a parameter contrived to accommodate the features of Wiener behavior (see discussion following Eqn. [1]). In the present invention the dependence of volatility on the standard deviation and average stipulates that changes in drift, because they imply changes in the average, thus imply changes in volatility and risk. Changes in volatility (and risk), however, can occur with changes in standard deviation only, drift (and average) remaining constant. Risk is also not a property of nonstationarity since both μ and α can be time-dependent while their ratio remains constant.

With this in mind, a very interesting result follows from Eqn. [27]. Consider the case where α is proportional to μ. For this case, Eqn. [27] reduces to

$$\frac{Δ P ( t )}{P ( t )} = \frac{Δμ}{μ} + ( \frac{α}{μ} ) Δ Y , \qquad [ 31 ]$$

since the time derivative of α/μ is zero. This result suggests a practical definition of risk as that property of market behavior that manifests when asset average and standard deviation are not changing with respect to time in a manner proportional to one another; i.e., when P/μ is strictly nonstationary (as, in reality, it always is). Further, it establishes that risk, unlike volatility, is neither a consequence of randomness nor nonstationarity since Eqn. [31] is valid as long as α and μ change with time in a manner proportional to one another. In the prior art, corresponding to an idealized formulation, volatility is a parameter that multiplies a time series presumably emulating random fluctuations in asset price and, because of the nature of said time series, also creates risk. There is no risk in Eqn. [31], even though randomness (and possibly nonstationarity) is present. The reason for this anomaly is that when α is proportional to μ, the ratio (α/μ)²=σ²(t−t₀) is constant and σ=α/μ√(t−t₀) is therefore decreasing with respect to time. The time derivative of σ²t is therefore

$$\frac{ⅆ}{ⅆ t} [ {σ}^{2} ( t - {t}_{0} ) ] = {σ}^{2} + 2 σ ( \frac{ⅆ σ}{ⅆ t} ) ( t - {t}_{0} ) = 0. \qquad [ 32 ]$$

Substituting this into Eqn. [29] reveals that classical risk is still present but its effect is cancelled by a negative value of

$$σ \frac{ⅆ σ}{ⅆ t} ( t - {t}_{0} ) .$$

This result establishes that volatility and risk, even though they are mathematically related, are not synonymous. This creates an added dimension of the underlying value of an asset and also answers the question posed by Schwert (“Why does stock market volatility change over time?,” Journal of Finance, Vol. 44, December 1989, 1115-1153); because asset standard deviation does not evolve with time in a manner proportional to the product of asset average and the square-root of the user-specified time window.

In summary, randomness always generates volatility but doesn't always generate risk. This precludes equating volatility and risk. It's possible for stationary price fluctuations (neutral market) to have the same volatility as do nonstationary price fluctuations (bull or bear markets). Thus volatility is not exclusive to nonstationary price fluctuations. Stationary price fluctuations (fully neutral markets) always generate time-dependent volatility but nonstationary price fluctuations do not. Lastly, although risk is an exclusive feature of nonstationary price fluctuations it is not a feature of all nonstationary price fluctuations.

For example, it is now a common investment strategy to create what are called volatility portfolios, which comprise long and short positions in various stock and index options. The advantage of such a portfolio is that it reduces stock-specific volatility risk and thus enhances the overall risk-adjusted rate of return. By employing the present invention, volatility and risk associated with particular portfolio components may advantageously be accounted for more accurately than in past practice.

The disclosed method is controlled by a computer program product for use with a computer system. Such implementation may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or analog communications lines) or a medium implemented with wireless techniques (e.g., microwave, infrared or other transmission techniques). The series of computer instructions embodies all or part of the functionality previously described herein with respect to the system. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). Of course, some embodiments of the invention may be implemented as a combination of both software (e.g., a computer program product) and hardware. Still other embodiments of the invention are implemented as entirely hardware.

Any publications mentioned herein are indicative of the level of skill in the art to which the present invention pertains. These publications are incorporated by reference to the same extent as if each were specifically and individually incorporated by reference.

The present examples, along with methods and procedures, are representative of preferred embodiments. They are exemplary and are not intended as limitations on the scope of the present invention. Changes therein and other uses will occur to those skilled in the art which are encompassed within the spirit of the invention as defined by the scope of the appended claims.

I claim:

1. A method for providing at least one real-time measure of performance of the value of an asset characterized by a price, the method comprising:
a. calculating a running average of the price of the asset defined over a specified time duration and at specified instants;
b. calculating at each specified instant a time-dependent deviation from the running average;
c. expressing the price of the asset as a sum of the running average plus a set of time-dependent deviations from the running average;
d. associating with the asset a measure of performance of the value of the asset based at least on time derivatives of a function of the average function and the standard deviation of the time-dependent differences.

2. A method according to claim 1, further comprising a step of expressing the set of time-dependent deviations from the running average as a product of a standard deviation and a set of deviations of unit variance.

3. A method according to claim 1, wherein the measure is an instantaneous drift equal to the ratio of a time-derivative of the running average to the running average.

4. A method according to claim 1, wherein the measure is an instantaneous volatility equal to a ratio of the standard deviation to the product of the running average and a square root of an elapsed duration.

5. A method according to claim 1, wherein the measure is an instantaneous risk proportional to a square of the ratio of the standard deviation to the running average.

6. A method according to claim 1, wherein the measure is an instantaneous return equal to the product of risk-adjusted drift and a specified time interval plus a difference in the ratio of the rapidly changing part to the running average, corresponding to the specified time interval.

7. A method for presenting an investor with a choice of investments, the method comprising:
a. presenting a list of assets;
b. characterizing each asset in the list by an instantaneous drift, an instantaneous volatility, an instantaneous risk, and an instantaneous return,
wherein the instantaneous risk is established in accordance with the method of claim 3.

8. A method according to claim 7, wherein the instantaneous volatility is established in accordance with the method of claim 4.

9. A method according to claim 7, wherein the instantaneous risk is established in accordance with the method of claim 5.

10. A computer program product for providing at least one real-time measure of performance of the value of an asset characterized by a price, the computer program product comprising:
a. an averager for calculating an average function equal to a time-ordered set of running averages of the price of the asset over a specified number of intervals, each interval of specified duration;
b. a differencer for calculating a time-ordered set of time-dependent differences of the price of the asset with respect to the running averages of the price of the asset at each of the specified intervals;
C. a computer program code module for expressing a price fluctuation function of the asset as a sum of the average function plus the time-ordered set of time-dependent differences;
d. a computer program code module for associating with the asset a measure of performance of the value of the asset based at least on time derivatives of a function of the average function and the standard deviation of the time-dependent differences.
